(19) United States
(12) Patent Application Publication
(10) Pub. No.: US 2009/0086304 A1
(43) Pub. Date: Apr. 2, 2009

(54) DIFFRACTION-TYPE OPTICAL MODULATOR AND DISPLAY APPARATUS INCLUDING THE SAME

(75) Inventors: Victor YURLOV, Suwon-si (KR); Haeng-Seok YANG, Bucheon-si (KR); Sang-Kyeong YUN, Suwon-si (KR); Anatoliy LAPCHUK, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/199,754

(22) Filed: Aug. 27, 2008

(30) Foreign Application Priority Data
Aug. 31, 2007 (KR) 10-2007-0088096

(51) Int. Cl. G02B 26/02; G02F 1/21

(52) U.S. Cl. 359/290

(57) ABSTRACT

Disclosed are a diffraction-type optical modulator and a display apparatus including the same. The diffraction-type optical modulator includes: a board; a lower mirror formed on the board; an upper mirror located apart from the lower mirror by a predetermined gap, having a hole, separated into at least two ridges by the hole, and movable up and down; and, an actuator moving the upper mirror in accordance with a driving signal and changing the separation distance, whereas a part of incident light beam reflects from the upper mirror, the rest of the incident light beam passes through the hole and reflects from the lower mirror, and then passes through the hole. A contrast ratio can be maximized by using the relation between the width of the hole and the ridge of an upper mirror, the ridge being measured in parallel with the direction of distribution of diffraction gratings.

### CROSS-REFERENCE TO RELATED APPLICATION

This application claims the benefit of Korean Patent Application No. 10-2007-0088096, filed with the Korean Intellectual Property Office on Aug. 31, 2007, the disclosure of which is incorporated herein by reference in its entirety.

### BACKGROUND OF THE INVENTION

1. Technical Field

The present invention relates to a display apparatus using an optical modulator, more particularly to a display apparatus having an improved contrast ratio through adjustment of the size of the hole of the optical modulator.

2. Description of the Related Art

Generally, an optical signal processing has advantages of a high speed, parallel processing ability and high-capacity information processing in contrast to conventional digital information processing incapable of processing a large amount of data in real time. In addition, research has been devoted to application of the optical signal processing to a design and manufacture of a binary phase filter, an optical logic gate, an optical amplifier, an optical element and an optical modulator. The optical modulator is used in fields such as an optical memory, an optical display, a printer, an optical interconnection and a hologram and the like, and research and development have been devoted to an optical beam scanning apparatus using the optical modulator.

Such an optical beam scanning apparatus in an image forming apparatus, for example, a laser printer, an LED printer, an electronic picture copy machine, a word processor and a projector and the like, spots an optical beam on a photosensitive medium and performs a function of forming an image through scanning.

As a projection TV, etc. have been recently developed, the modulator and a scanner are now used as means for scanning light beams onto a screen.

The optical modulator modulates a light beam incident from a light source and outputs the modulated light beam. Here, a plurality of ribbons including a hole are arranged in a line in the optical modulator. One or more ribbons are responsible for one pixel and output a modulated light beam corresponding to a linear image (a vertical scanning line or a horizontal scanning line). The scanner scans the modulated light beam from the optical modulator in a predetermined direction and represents a two-dimensional image representing a plurality of successive linear images on the screen.

When one ribbon is responsible for one pixel, a case is assumed where the darkest illumination is represented. An ideal destructive interference is formed only when a light field reflecting from the upper mirror surface on the ribbon has a phase reverse to that of a light field transmitting the hole of the ribbon and reflecting from the lower mirror surface and also has the same absolute value of the amplitude as that of the light field transmitting the hole of the ribbon and reflecting from the lower mirror surface. There is, however, a problem that a contrast ratio (CR), i.e., a ratio of the darkest luminance representable by a pixel to the brightest luminance representable by a pixel, is reduced because residual light beams are output due to the amplitude imbalance of each light field.

### SUMMARY

The present invention provides a diffraction-type optical modulator for maximizing a contrast ratio by using the relation between the width of the hole and the ridge of an upper mirror, the ridge being measured in parallel with the direction of distribution of diffraction gratings, and a display apparatus including the same.

An aspect of the present invention features a diffraction-type optical modulator including: a board; a lower mirror formed on the board; an upper mirror located apart from the lower mirror by a predetermined gap, having a hole, separated into at least two ridges by the hole, and movable up and down; and, an actuator moving the upper mirror in accordance with a driving signal and changing the separation distance, whereas a part of incident light beam reflects from the upper mirror, the rest of the incident light beam passes through the hole and reflects from the lower mirror, and then passes through the hole.

In one embodiment, a width of the ridge and a width of the hole can be determined by an initial separation distance between the upper mirror and the lower mirror. In this case, the initial separation distance can be intended to output either a maximum light power at 0^{th} diffraction order or a minimum light power at 1^{st} diffraction order when a light beam reflected from the upper mirror and a light beam reflected from the lower mirror overlap with each other. The more the initial separation distance increases, the more a difference between the width of the ridge and the width of the hole reduce. The width of the hole is larger than the width of the ridge.

In another embodiment, the width of the ridge and the width of the hole can be determined by a tilting of the upper mirror. Here, the more a degree of the tilting increases, the more the difference between the width of the ridge and the width of the hole can increase.

In yet another embodiment, the width of the ridge and the width of the hole can be determined by the initial separation distance between the upper mirror and the lower mirror and by the tilting of the upper mirror.

Another aspect of the present invention features a display apparatus that includes a light source, an optical modulator modulating an incident light beam from the light source in accordance with an image signal and outputting the modulated light beam, and a projector projecting the modulated light beam on a predetermined area. The optical modulator corresponds to a diffraction-type optical modulator mentioned above.

### BRIEF DESCRIPTION OF THE DRAWINGS

FIG. 1 is a view illustrating a schematic configuration of a display apparatus according to the present invention.

FIG. 2 is a perspective view illustrating an optical modulator included in the display apparatus illustrated in FIG. 1.

FIG. 3 is a development figure illustrating an embodiment of the display apparatus illustrated in FIG. 1 on the basis of an optical axis.

FIG. 4 is a development figure illustrating another embodiment of the display apparatus illustrated in FIG. 1 on the basis of an optical axis.

FIG. 5 is a view illustrating the intensity and phase distribution of an incident light beam within one ribbon of an optical modulator.

FIG. 6 is a view illustrating the intensity and phase distribution of an incident light beam within one ribbon of an optical modulator.

FIG. 7 is a view illustrating the amplitude and phase distribution of a reflected light beam.

FIG. 8 is a cross sectional view illustrating a ribbon of an optical modulator having a bending property.

FIGS. 9 and 10 are graphs illustrating contrast ratios having a relative hole-upper mirror difference as an argument.

FIG. 11 is a graph illustrating an optimal ridge-hole difference for a bending sag at 0^{th} diffraction order.

FIG. 12 is a graph illustrating an optimal ridge-hole difference for a bending sag at 1^{st} diffraction order.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. In the following description of the present invention, the detailed description of known technologies incorporated herein will be omitted when it may make the subject matter unclear.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, an embodiment of the present invention will be described in detail with reference to the accompanying drawings.

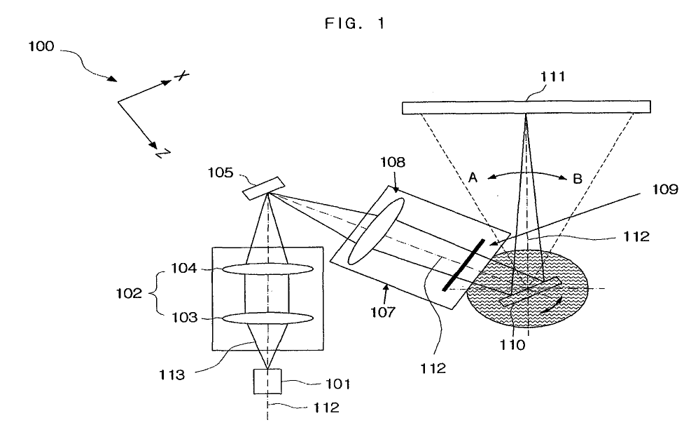

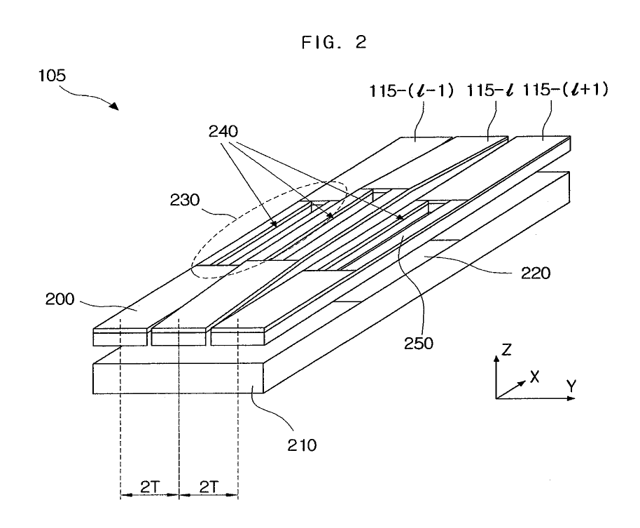

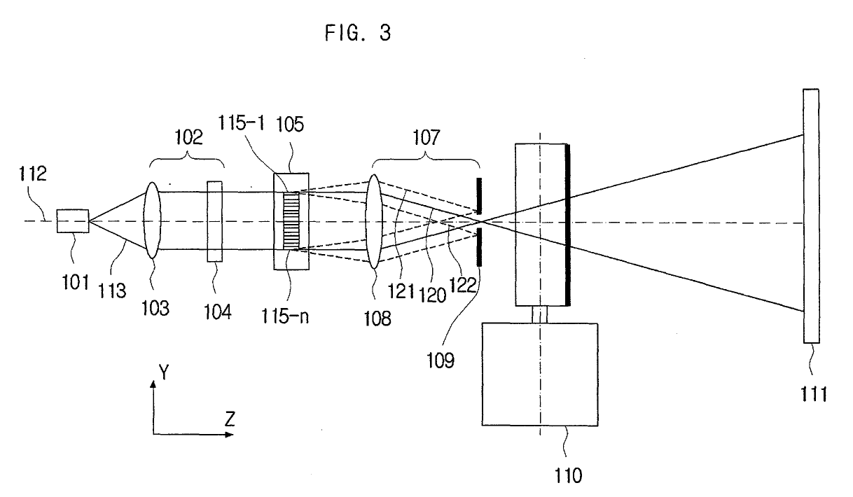

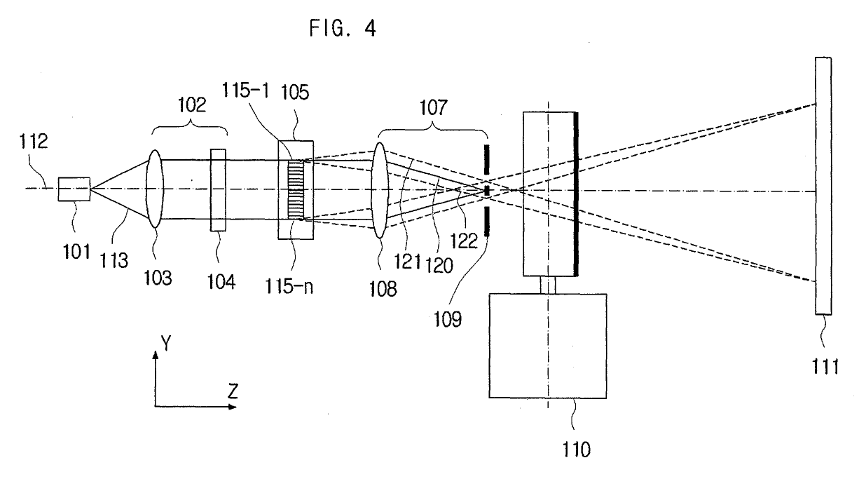

FIG. 1 illustrates a schematic configuration of a display apparatus according to the present invention. FIG. 2 illustrates a perspective view of an optical modulator included in the display apparatus illustrated in FIG. 1. FIG. 3 is a development figure illustrating an embodiment of the display apparatus illustrated in FIG. 1 on the basis of an optical axis. FIG. 4 is a development figure illustrating another embodiment of the display apparatus illustrated in FIG. 1 on the basis of an optical axis.

The display apparatus 100 includes a light source 101, an illumination optical system 102, an optical modulator 105, a projection optical system 107 and a scanning mirror 110. It can be easily understood by those skilled in the art that the illumination optical system 102 and the projection optical system 107 are included in a general display apparatus.

The light source 101 radiates a light beam 113. The light beam 113 penetrates the illumination optical system 102 and is incident on the optical modulator 105 along the optical axis 112. The light source 101 can be a laser diode, a Vertical External Cavity Surface-Emitting Laser (VECSEL) or an apparatus performing a similar function thereto.

The illumination optical system 102 includes a condenser lens 103 condensing the light beam 113 radiated from the light source 101 in parallel with the optical axis 112, a cylindrical lens 104 focusing the light beam 113 condensed by the condensing lens 103 on the optical modulator 105. In addition, while not being shown, it is also possible to transmit the light beam 113 to the cylindrical lens 104 by using a diverging lens and a collimating lens. The illumination optical system 102 focuses the light beam 113 from the light source 101 to be a line beam in the Y-axis direction so that the light beam 113 can be incident on the optical modulator 105 in the form of a linear light beam. Here, the light beam 113 into the optical modulator 105, i.e., the incident light beam has an incident angle for the modulated light beam to reach a spatial frequency filter 109 of the projection optical system 107.

Not only the illumination optical system 102 but other optical systems can illuminate the incident light beam 113 on the optical modulator 105. Also, it should be understood by those skilled in the art that the lens used in the present invention can be replaced by a compound lens or a reflexible optical element as well as a single component lens.

A plurality of ribbons 115-l to 115-n (where n is a natural number) having upper mirror layers are linearly arranged along the focal line (here, in the Y-axis direction of FIG. 2) of the cylindrical lens 104. The optical modulator 105 drives each of ribbons 115-l to 115-n in an up and down direction according to the electrical signals of the drive circuit thereof (not shown) and modulates the incident light beam.

The method of the optical modulator is classified into a direct method of controlling the on/off of light and an indirect method of using reflection and diffraction. The indirect method may be classified into an electrostatic method and a piezoelectric method. Here, the optical modulator can be applied to the present invention regardless of driving method thereof.

An electrostatic drive-type grating optical modulator disclosed in U.S. Pat. No. 5,311,360 includes a reflecting surface unit and a plurality of transformable reflection-type ribbon suspended on the upper part of the board and uniformly separated. First, an insulation layer is deposited on the silicon board, and then deposition processes of both a sacrifice silicon dioxide film and a silicon nitride film are performed. The silicon nitride film is patterned with a ribbon and a part of a silicon dioxide layer is etched so that the ribbon can be maintained on a spacer oxide layer by a nitride frame. A grating amplitude of such a modulator, the grating amplitude being limited by a vertical distance “d” between the reflective surface on the ribbon and the reflective surface on the board can be controlled by supplying a voltage between the ribbon (that is, the reflective surface of the ribbon, which performs a function of the first electrode) and the board (that is, a conductive film of the lower part of the board, which performs a function of the second electrode). While the following description will be focused on a piezoelectric type optical modulator for the sake of convenience of description and understanding of the present invention, an electrostatic type optical modulator can be also applied in the same way.

The optical modulator 105 includes a lot of ribbons 115-l to 115-n (hereinafter, referred to as 115). The following description will be focused on l−1^{th}, l^{th} and l+1^{th} ribbons 115-(l−1), 115-l and 115-(l+1) (here, 2<t<n) with reference to FIG. 2. FIG. 2 illustrates that the l−1^{th} ribbon 115-l and the l+1^{th ribbon 115-(}l+1) do not operate and the l^{th} ribbon 115-l operates.

The optical modulator 105 includes a insulation layer 210 located on the board (not shown), a structure layer 200 of which a central part 230 is located apart from the insulation layer 210 by a predetermined gap and a piezoelectric actuator (not shown), which is formed at both sides of the structure layer 200, moving the central part 230 of the structure layer 200 up and down. An upper mirror 250 having an optical reflectivity is formed on a part of the surface including the central part 230 of the structure layer 200. Since the structure layer 200 and the upper mirror 250 have long shapes in one direction, they are designated together as a ribbon 115 in all.

When at least one hole 240 is formed at the central part 230 of the ribbon 115, one or more two ribbons 115 are responsible for one pixel of an image. While the hole 240 is illustrated as a long rectangular-shaped slit in the length direction (the X-axis direction of FIG. 2) of the ribbon 115, the hole can have various shapes such as a circle, an ellipse, a polygon and the like. In this case, a lower mirror 220 having the optical reflectivity should be formed on the surface of the insulation layer 210. It is possible to adjust the gap between the upper mirror 250 on the surface of the ribbon 115 and the lower mirror 220 of the insulation layer by supplying a voltage to the piezoelectric actuator and moving the ribbon 115 up and down. A path difference is generated between the light beam reflected from the upper mirror 250 and the light beam reflected from the lower mirror 220, so that diffraction (interference) is generated.

As described above, the brightness of one pixel can be represented by using the path difference between the reflected light beams. Each reflected light beam produces +1^{st} order D+1 and −1^{st} order D−1 diffracted light beams 121 and 122 as well as 0^{th} order diffracted light beam 120 in accordance with the diffraction (interference) principle.

FIG. 3 illustrates that the spatial frequency filter 109 included in the projection optical system 107 transmits the 0^{th} order diffracted light beam 120 and stops transmitting the +1^{st} order D+1 and −1^{st} order D−1 diffracted light beams 121 and 122. FIG. 4 illustrates that the spatial frequency filter 109 included in the projection optical system 107 transmits the +1^{st} order D+1 and −1^{st} order D−1 diffracted light beams 121 and 122 and stops transmitting the 0^{th} order diffracted light beam 120.

Referring to FIG. 3, the optical modulator 105 outputs a modulated light beam from an incident light beam in order that one or more two ribbons 115 represent the brightness of one pixel of an image. The modulated light beam, as described above, includes multi-order diffracted light beams 120, 121 and 122. The optical modulator 105 represents a linear image by means of many ribbons 115 arranged in parallel with the Y-axis direction of FIG. 4. At a particular point of time, the optical modulator 105 represents the brightness of one linear image (vertical direction or horizontal direction) forming a two-dimensional image. The scanning mirror 110 allows the corresponding linear image to be represented at a particular point of a screen 111. The optical modulator 105 modulates a lot of linear images in accordance with a scan frequency and the scanning mirror 110 scans the modulated linear images in a predetermined direction (unidirection or bidirection), so that the two-dimensional image can be represented as a whole.

The modulated light beams 120, 121 and 122 from the optical modulator 105 passes through the projection optical system 107 and arrives at the scanning mirror 110. The projection optical system 107 includes a projection lens 108 and the spatial frequency filter 109. The projection lens 108 spreads the modulated light beams 120, 121 and 122 of linear images into two-dimensional spatial images (a form where the linear images are spread to the right and left) and then allows the modulated light beams to be finally projected in the form of linear images on the screen 111 through the scanning mirror 110. The spatial frequency filter 109 selectively passes the 0^{th} order diffracted light beam 120 (illustrated in FIG. 3) or ±1^{st} order diffracted light beams 121 and 122 (illustrated in FIG. 4.) among the modulated light beams.

A galvano mirror returns to its original position through a first scan motion (A) and projects an output light beam of a one-dimensional line image on the screen 111 through a second scan motion (B), and vice versa. Additionally, a polygon mirror (not shown) instead of the galvano mirror is provided to rotate unidirectionally so that the output light beam can be projected on the screen 111. The galvano mirror and the polygon mirror are commonly designated as a scanning mirror in the present invention.

It is assumed that one mirror 115 deals with one pixel of a linear image in the following description.

In using the display apparatus 100, a contrast ratio defined as a ratio of a light power portion at the time of an ON-mode of the optical modulator 105 to a light power portion at the time of an OFF-mode of the optical modulator 105 is a significant parameter.

When there are no ambient light and no parasitic optical background, the optical modulator 105 itself provides a limit of the contrast ratio. Such a contrast ratio is reduced due to a residual power at the time of the OFF-mode of the optical modulator 105. The more the residual power is, the more the contrast ratio is reduced.

The main reason why the residual power cannot be zero is an amplitude imbalance at the operating diffraction order (e.g., 0^{th} order in FIG. 3, +1^{st} or −1^{st} order in FIG. 4) of the optical modulator 105 between two components of a light electromagnetic field having complex amplitude. Here, the two components are both a first component of a light field reflected from the lower mirror 220 and a second component of a light field reflected from the upper mirror 250.

When the optical modulator 105 is in an OFF-mode, a phase difference between the two components is (2n+1)π (here, n is an integer value equal to or greater that zero). In this case, the two components have reverse phases to each other. When an absolute value of amplitude of one component is equal to that of the other component, the residual power is zero and the contrast ratio has so infinite a value or very large amount of value that the ambient light and parasitic optical background can use the contrast ratio.

However, two components of a conventional optical modulator could not have absolute values having exactly the same amplitude as each other, there are problems that the amplitude imbalance is inevitable and the residual power is not zero.

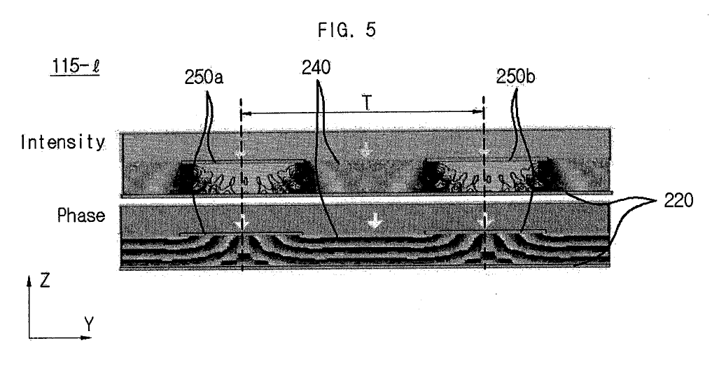

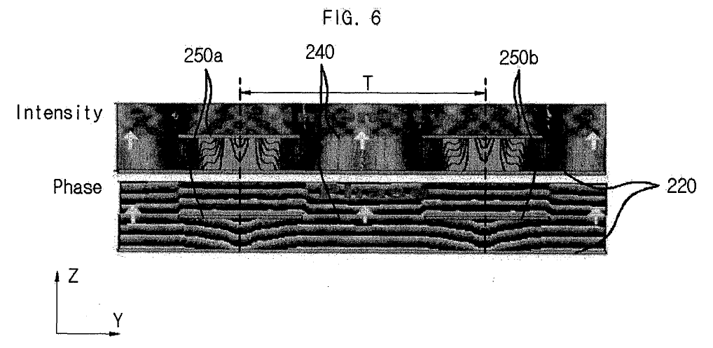

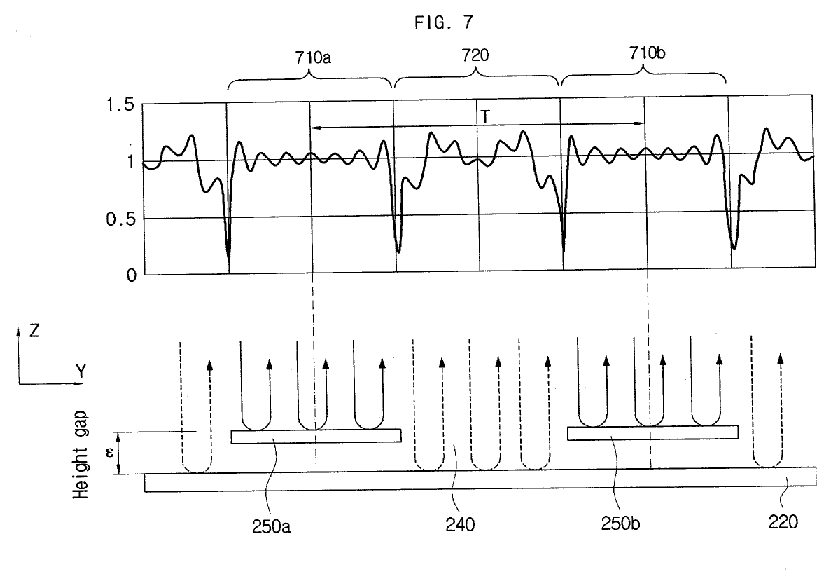

FIG. 5 illustrates an intensity and phase distribution of an incident light beam within one ribbon of an optical modulator. FIG. 6 illustrates an intensity and phase distribution of an incident light beam within one ribbon of an optical modulator. FIG. 7 illustrates an amplitude and phase distribution of a reflected light beam. The l^{th} ribbon 115-l illustrated in FIG. 2 will be focused in the following description. It is assumed that one hole 240 is formed.

The hole 240 separates the upper mirror 250 on the structure layer 200 into a first ridge 250a and a second ridge 250b. “T” represents a distance between the center of the ridge 250a and the center of the ridge 250b.

The first component corresponds to a light beam which is incident through the hole 240 formed on the structure layer, which is partially truncated to a certain extent, and which travels the same distance as a height gap and then travels the same distance as the height gap in a reverse direction thereto. Here, the height gap refers to a distance between the upper mirror 250 and the lower mirror 220. A diffraction effect causes the shape of amplitude distribution of the light beam to be obtuse and wider than the hole 240 (see the reference number 720 of FIG. 7).

Also, the second component corresponds to a light beam reflected from the upper mirror 250. The second component is neither diffracted nor partially truncated to a certain extent. Accordingly, the second component has a nearly square-shaped amplitude distribution (see the reference numbers 710a and 710b of FIG. 7).

Referring to FIG. 7, it is understood that the first component 720 and the second components 710a and 710b have different amplitude distributions from each other due to the diffraction effect and the truncation effect. Accordingly, the two components have different diffraction patterns. As the height gap increases, the difference increases much more. Accordingly, since the second first component is less affected by the diffraction and truncation effects than the first second component, the amplitude imbalance occurs so that the contrast ratio of the optical modulator is reduced. The more the height gap increases, the more the amplitude imbalance increases and the more the contrast ratio decreases.

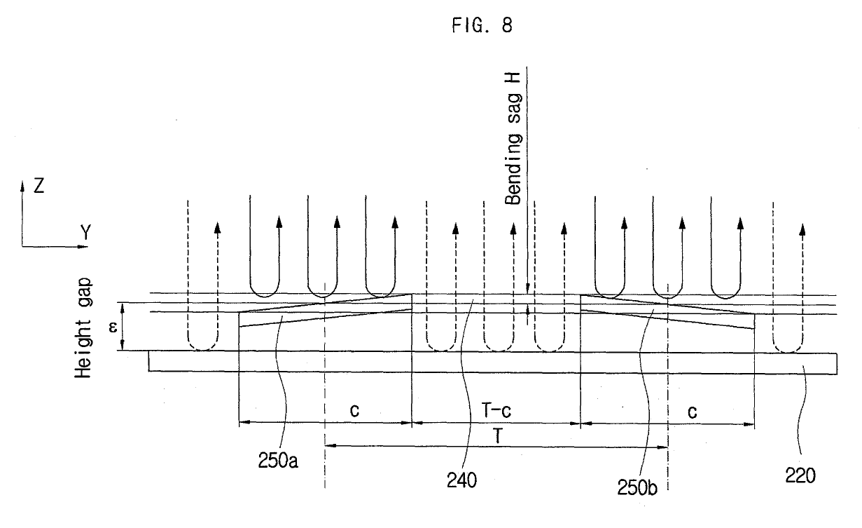

Accordingly, an optical modulator for compensating the amplitude imbalance and increasing the contrast ratio thereof by changing the size of the hole 240 (or the first and the second ridges 250a and 250b) of the structure layer will be described with reference to the FIG. 8 in the following description. FIG. 8 illustrates a cross section view of a ribbon of the optical modulator having a bending property.

The optical modulator 105 corresponds to a multi-layer structure as described above with reference to FIG. 2. That is, the optical modulator 105 is constituted by layers formed of mutually different materials (for example, silicon nitrides, metallic materials, piezoelectric materials and the like). Such materials have mutually different thermal expansion coefficients. The ribbon of the optical modulator 105 is transformed and has a curved or bended shape due to different expansions according to layers at a high temperature (bimorph effect). After cyclically adding heating and cooling during the manufacturing process, the ribbon of the optical modulator 105 has a slightly curved shape as illustrated in FIG. 8 due to a residual stress and deformation.

M (m is a natural number equal to or larger than 2) number of diffraction structures are repetitively disposed within one pixel. The diffraction structure refers to one part for outputting the light beam reflected by the upper mirror and the light beam reflected by the lower mirror. A repetition period of the diffraction structure is “T” and a pixel array period is “P” (=mT). One ribbon 115 is responsible for one pixel of an image. The m mentioned above becomes 2 on the basis of a case where one hole 240 is formed in each ribbon 115 (see FIG. 2). In other words, two diffraction structures are included within one pixel (see FIGS. 2 and 8).

The widths of the first ridge 250a and the second ridge 250b are “c”, respectively. When the diffraction structure period is T, it is assumed that “σ”=c−0.5 T. When the c is larger than 0.5 T, the σ becomes a positive number. When the c is less than 0.5 T, the σ becomes a negative number.

The amplitude imbalance is defined as the relation among the size of the hole 240/the ridges 250a and 250b, the height gap and bending degree. The bending degree can be specified by the value of a bending sag of “H” illustrated in FIG. 8.

A diffraction light field reflected from the optical modulator can be represented by means of a Fourier transform as described in Equation (1).

Fᵣ(v)=∫Sᵣ(y)e^{-jvy}dy Equation (1),

where “v” (=k cos β) is a spatial frequency, “β” is an angle between a spatial harmonic wave vector and the Y-axis, and “k” (=2π/λ) is a wave number. F(u,v,z) is obtainable by using a free space transfer function (FSTF).

Sᵣ(y)=S_{dn}(y)+Sᵤₚ(y) Equation (2)

where Sᵣ(y) is a complex field amplitude of the light beam reflected from the optical modulator defined on the plane where z=0, and includes two components, that is, S_{dn}(y), i.e., a field reflected from the lower mirror 220 and Sᵤₚ(y), i.e., a field reflected from the upper mirror 250.

S_{dn}(y), the first component can be gradually represented through the following Equation 3 to 11. Considering that the first component passes through the hole 240 of the structure layer, S_{dn}(y) is represented as Equation (3) and (4) in a spatial domain and a frequency domain, respectively.

S₁(y)=Sᵢ(y)t(y) Equation (3)

F₁(v)=∫S₁(y)e^{-jvy}dy Equation (4)

t(y) is described in FIG. 5 below.

$$t ( y ) = rect ( \frac{y}{0.5 T - σ} ) ⊗ {{\sum }_{n}}^{∞} δ ( y - nT ) , \qquad Equation ( 5 )$$

where t(y) is a transmittance function of the structure layers of all the ribbons, δ(y) is a Dirac delta function, and Sᵢ(y)=1-incident field. The following Equation (6) describes rect(y).

$$rect ( y ) = \{ \begin{matrix}1 , & if - 0.5 < y < 0.5 \\ 0 , & otherwise\end{matrix} \qquad Equation ( 6 )$$

The incident light, which has passed through the hole 240, propagates to the lower mirror 220, reflects from the lower mirror 220 and then returns to the upper mirror 250. Accordingly, the incident light has a total propagation distance of 2ε. Here, “ε” is a value of a height gap.

A field amplitude after a round trip is represented by the following Equation (7).

F₂(v)=F₁(v)FSTF(v,2ε) Equation (7),

where FSTF is a free space transfer function and is described in the following Equation (8).

$$FSTF ( v , z ) = exp \{ j z \sqrt{{k}^{2} - {v}^{2}} \} \qquad Equation ( 8 )$$

After the light field represented in Equation (7) passes through the hole 240 of the structure layer again, a vignetting, as described in Equation (9), is represented as a convolution in a spatial frequency domain.

$${F}_{dn} ( v ) = \frac{1}{2 π} \int {F}_{2} ( {v}^{′} ) T ( v - {v}^{′} ) d {v}^{′} \qquad Equation ( 9 )$$

T(v) is a Fourier transform of the transmittance function of t(y). Equation (10) represents T(v).

T(v)=∫t(y)e^{-jvy}dy Equation (10),

where the first component of Equation (2) mentioned above is represented by Equation (11) by applying an inverse Fourier transform to Equation (9).

$${S}_{dn} ( y ) = \frac{1}{2 π} \int {F}_{dn} ( v ) {e}^{- j vy} d v \qquad Equation ( 11 )$$

The second component of Equation (2), which is the light field reflected from the upper mirror 250, can be represented Equation (12) below.

S_{up s}(y)=Sᵢ(y)r(y) Equation (12)

An upper mirror reflection function of r(y) can be provided as Equation (13) below.

$$r ( y ) = {r}_{0} ( y ) ⊗ {{\sum }_{n}}^{∞} δ ( y - n 2 T ) , \qquad Equation ( 13 )$$

where a reflection function of one ribbon, i.e., r₀(y) is represented by the following Equation (14).

$${r}_{0} ( y ) = rect ( \frac{y - 0.5 T}{0.5 T + σ} ) exp \{ - j2 kH \frac{π}{T} ( y - \frac{T}{2} ) \} + rect ( \frac{y + 0.5 T}{0.5 T + σ} ) exp \{ j2 kH \frac{π}{T} ( y + \frac{T}{2} ) \} , \qquad Equation ( 14 )$$

where, as illustrated in FIG. 6, a linear approximation of a ribbon bending effect in accordance with the tilting of each of ridges 250a and 250b of a ribbon is used.

A sum of light fields reflected from the optical modulator in the spatial frequency domain can be obtained by replacing Equation (2) with Equations (11) and (12), and then replacing Equation (1) with Equation (2).

Equation (1) corresponds to an infinite sum of spatial harmonics. A light power corresponding to a predetermined diffraction order can be obtained through a squared module of the element of a predetermined component

Light powers from Equation 15 and 16 can be obtained through mathematical transform. Equation (15) corresponds to a light power of the 1^{st} diffraction order and Equation (16) corresponds to a light power of the 0^{th} diffraction order.

$$\begin{matrix}\begin{matrix}E 1 ( ɛ , \frac{σ}{T} , H ) = \vert {( \frac{1}{2} - \frac{σ}{T} )}^{2} {{\sum }_{n}}^{∞} Sin c [ ( \frac{1}{2} - \frac{σ}{T} ) n π ] \\ Sin c [ ( \frac{1}{2} - \frac{σ}{T} ) ( 1 - n ) π ] exp \{ j2ɛ k \sqrt{1 - {[ ( 1 - n ) \frac{λ}{T} ]}^{2}} \} - \\ - \frac{1}{2} ( \frac{1}{2} + \frac{σ}{T} ) \{ Sin c [ π ( \frac{1}{2} + \frac{σ}{T} ) ( 1 + kH ) ] + \\ { Sin c [ π ( \frac{1}{2} + \frac{σ}{T} ) ( 1 - kH ) ] \} \vert}^{2}\end{matrix} & Equation ( 15 ) \\ \begin{matrix}E 0 ( ɛ , \frac{σ}{T} , H ) = \vert ( \frac{1}{2} + \frac{σ}{T} ) Sin c [ π ( \frac{1}{2} + \frac{σ}{T} ) kH ] + \\ { {( \frac{1}{2} - \frac{σ}{T} )}^{2} {{\sum }_{n}}^{∞} Sin c [ ( \frac{1}{2} - \frac{σ}{T} ) n π ] exp \{ j2ɛ k \sqrt{1 - {( n \frac{λ}{T} )}^{2}} \} \vert}^{2}\end{matrix} & Equation ( 16 )\end{matrix}$$

When the optical modulator does not includes a bending property, light powers from Equation 17 and 18 can be obtained. Equation (17) corresponds to a light power of the 1^{st} diffraction order and Equation (18) corresponds to a light power of the 0^{th} diffraction order.

$$\begin{matrix}\begin{matrix}E 1 ( ɛ , \frac{σ}{T} ) = \vert {( \frac{1}{2} - \frac{σ}{T} )}^{2} {{\sum }_{n}}^{∞} Sin c [ ( \frac{1}{2} - \frac{σ}{T} ) n π ] \\ Sin c [ ( \frac{1}{2} - \frac{σ}{T} ) ( 1 - n ) π ] exp \{ j2ɛ k \sqrt{1 - {[ ( 1 - n ) \frac{λ}{T} ]}^{2}} \} - \\ { ( \frac{1}{2} + \frac{σ}{T} ) Sin c [ π ( \frac{1}{2} + \frac{σ}{T} ) ] \vert}^{2}\end{matrix} & Equation ( 17 ) \\ \begin{matrix}E 0 ( ɛ , \frac{σ}{T} ) = \vert \frac{1}{2} + \frac{σ}{T} + {( \frac{1}{2} - \frac{σ}{T} )}^{2} {{\sum }_{n}}^{∞} Sin c [ ( \frac{1}{2} - \frac{σ}{T} ) n π ] \\ { exp \{ j2ɛ k \sqrt{1 - {( n \frac{λ}{T} )}^{2}} \} \vert}^{2}\end{matrix} & Equation ( 18 )\end{matrix}$$

A contrast ratio of the 1^{st} diffraction order can be calculated in the following Equation (19) and a contrast ratio of the 0^{th} diffraction order can be calculated in the following Equation (20).

$$\begin{matrix}C {1}_{N / 2} ( \frac{σ}{T} , H ) = \frac{E 1 ( \frac{2 N + 1}{4} λ , \frac{σ}{T} , H )}{E 1 ( \frac{N}{2} λ + ɛ {1}_{N} , \frac{σ}{T} , H )} & Equation ( 19 ) \\ C {0}_{N / 2} ( \frac{σ}{T} , H ) = \frac{E 0 ( \frac{N}{2} λ , \frac{σ}{T} , H )}{E 0 ( \frac{2 N + 1}{4} λ + ɛ {0}_{N} , \frac{σ}{T} , H )} , & Equation ( 20 )\end{matrix}$$

where N is an integer larger than 0, and N/2 is a discrete number of a wavelength for providing an OFF-mode with respect to the 1^{st} diffraction order and an ON-mode with respect to the 0^{th} diffraction order, the discrete number being equal to the height gap of the optical modulator.

When the height gap is an odd multiple of λ/4, the light power of the 1^{st} diffraction order approaches the maximum value. When the height gap is an integer multiple of λ/4, the light power of the 0^{th} diffraction order approaches the maximum value.

Precisely, numerators of Equations (19) and (20) acquire the maximum values from a slightly different height gap. Maximum light powers may be a little different. However, the maximum light powers have obtuse shapes and the difference is extremely small. Accordingly, it is assumed that the height gap is (2N+1)λ/4 with respect to the 1^{st} diffraction order and is Nλ/2 with respect to the 0^{th} diffraction order.

ε1_{N} and ε0_{N} are additional height movements for providing the minimum residual output in the denominators of Equation (19) and (20) in accordance with the 1^{st} diffraction order and the 0^{th} diffraction order, respectively.

When a wavelength number of N and a bending sag of H are fixed, the contrast ratio corresponds to a function having arguments such as a relative ridge-hole difference of σ/T and the additional height movement, i.e., ε1_{N} or ε0_{N}.

When the denominators of Equations (19) and (20) are zero, the contrast ratio becomes infinite, which signifies that an ideal destructive interference is formed between the first component and the second component due to the reverse phase and the same absolute value of the amplitude.

The right sides of Equation (15) and (16) are squared modules including sum of the two components. The first component is a light field reflected from the lower mirror 220 and the second component is a light field reflected from the upper mirror 250. The first component is a complex number and is dependent on the height gap of ε and is not dependent on the bending sag of H. The second component is a real number and is dependent on the bending sag of H and is not dependent on the height gap of ε. The first and second components are all dependent on the ridge-hole difference of a/T.

Equations (15) and (16) have the minimum value of zero only when the first component is a real number (only when the imaginary part of the first component is zero). From this condition, the additional height movements of ε1_{N} and ε0_{N} can be defined as functions of the relative ridge-hole difference of σ/T for an arbitrary N. Roots of the following Equations (21) and (22) are additional height movements.

$$\begin{matrix}\begin{matrix}Im \{ {{\sum }_{n}}^{∞} Sin c [ ( \frac{1}{2} - \frac{σ}{T} ) n π ] Sin c [ ( \frac{1}{2} - \frac{σ}{T} ) ( 1 - n ) π ] \\ exp [ j2 ( \frac{N}{2} λ + ɛ {1}_{N} ) k \sqrt{1 - {[ ( 1 - n ) \frac{λ}{T} ]}^{2}} ] \} = 0\end{matrix} & Equation ( 21 ) \\ \begin{matrix}Im \{ {{\sum }_{n}}^{∞} Sin c [ ( \frac{1}{2} - \frac{σ}{T} ) n π ] \\ exp [ j2 ( \frac{2 N + 1}{4} λ + {ɛ0}_{N} ) k \sqrt{1 - {( n \frac{λ}{T} )}^{2}} ] \} = 0\end{matrix} & Equation ( 22 )\end{matrix}$$

Numerical answers can be acquired through arrangement of σ/T of another value and several Ns (where, N=0, 2, 4, 6, corresponding to height gaps 0, λ, 2λ and 3λ). Consequently, for several Ns, additional height movements of ε1_{N}(σ/T) and ε0_{N}(σ/T) can be obtained, the ε1_{N}(σ/T) and ε0_{N}(σ/T) being functions of σ/T, i.e., the relative ridge-hole difference.

When N and H are fixed after replacement with respect to Equation (19) and (20), expressions for the contrast ratio as an σ/T function having one argument are acquired as described in the following Equations (23) and (24).

$$\begin{matrix}C {1}_{N / 2} ( \frac{σ}{T} , H ) = \frac{E 1 ( \frac{2 N + 1}{4} λ , \frac{σ}{T} , H )}{E 1 [ \frac{N}{2} λ + ɛ {1}_{N} ( \frac{σ}{T} ) , \frac{σ}{T} , H ]} & Equation ( 23 ) \\ C {0}_{N / 2} ( \frac{σ}{T} , H ) = \frac{E 0 ( \frac{N}{2} λ , \frac{σ}{T} , H )}{E 0 [ \frac{2 N + 1}{4} λ + ɛ {0}_{N} ( \frac{σ}{T} ) , \frac{σ}{T} , H ]} , & Equation ( 24 )\end{matrix}$$

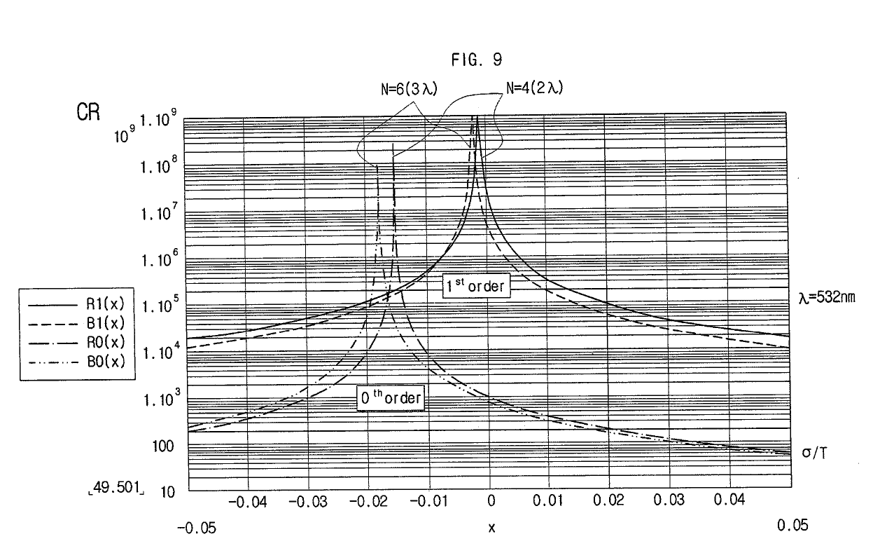

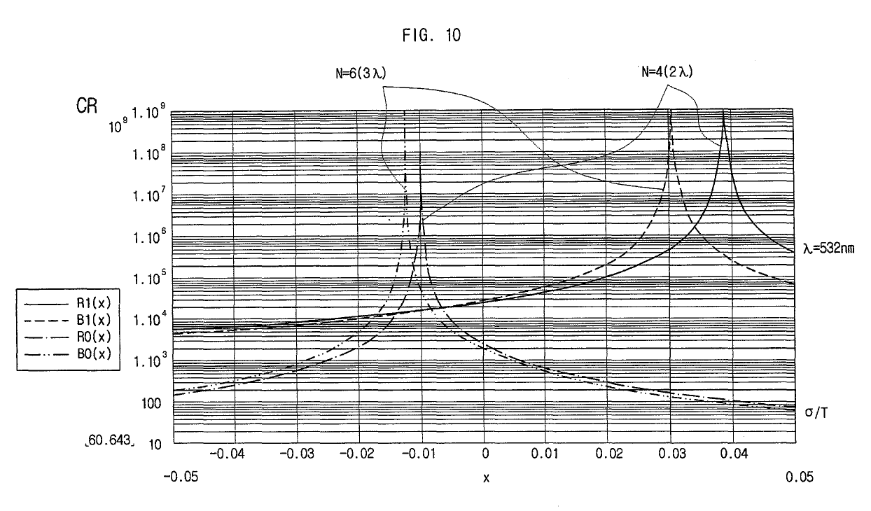

FIGS. 9 and 10 are graphs illustrating contrast ratios having a relative hole-upper mirror difference as an argument. Graphs according to Equation (23) and (24) mentioned above are illustrated in FIGS. 9 and 10, respectively. FIG. 9 illustrates a case where there is no bending property (H=0) and FIG. 10 illustrates a case where the bending sag of H is 20 nm.

Cases of the 1^{st} diffraction order and the 0^{th} diffraction order are illustrated and cases where initial height gaps are 2λ(N=4) and 3λ(N=6) are illustrated.

When there is no bending property, the hole is wider than the ridge. Accordingly, in the case where o/T is a negative number, the maximum contrast ratio (overall amplitude balance). The more the height gap increases, the more the ridge-hole difference increases further.

When bending is not zero (for example, H=20 nm), the optimal ridge-hole difference changes. Comparing FIG. 9 with FIG. 10, it can be noted that each graph has shifted to the right.

The optimal ridge-hole differences of [σ/T]1=Σ1_{N}(H) and [σ/T]0=Σ0_{N}(H) which provide the maximum contrast ratio under conditions of mutually different bending sag of H and the height gap of N=2ε/λ are defined. When the denominators of Equations (23) and (24) are zero, the contrast ratio is infinite. Accordingly, an equation for Σ1_{N}(H) and Σ0_{N}(H) is shown in the following Equations (25) and (26).

$$\begin{matrix}E 1 [ \frac{N}{2} λ + ɛ {1}_{N} ( {Σ1}_{N} ) , Σ {1}_{N} , H ] = 0 & Equation ( 25 ) \\ E 0 [ \frac{2 N + 1}{4} λ + {ɛ0}_{N} ( {Σ0}_{N} ) , {Σ0}_{N} , H ] = 0 & Equation ( 26 )\end{matrix}$$

The roots provide a definition of the optimal ridge-hole differences of Σ1_{N}(H) and Σ0_{N}(H) which can be used for an optimal optical modulator design.

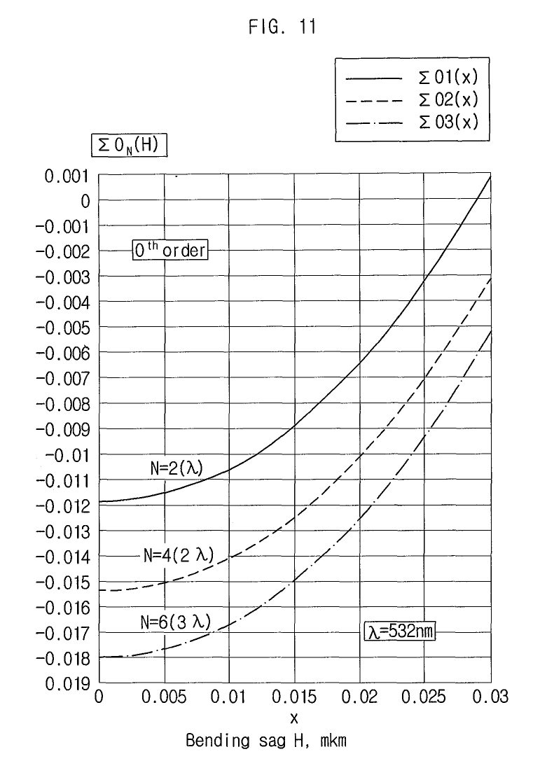

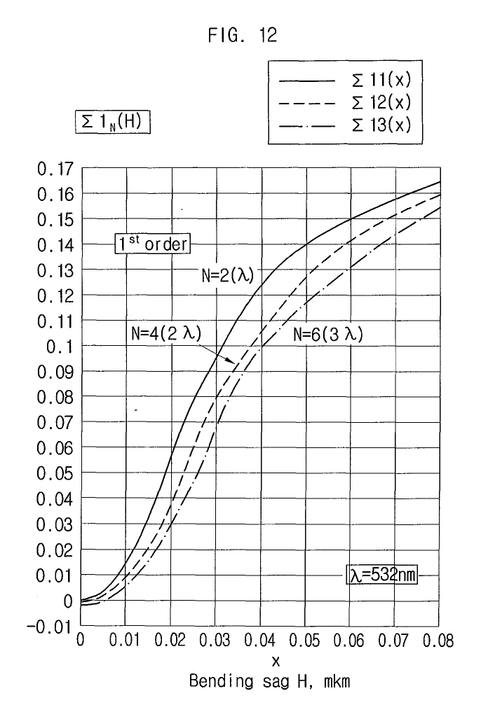

FIG. 11 is a graph illustrating an optimal ridge-hole difference for a bending sag at 0^{th} diffraction order. FIG. 12 is a graph illustrating an optimal ridge-hole difference for a bending sag at 1^{st} diffraction order. When initial height gaps are λ, 2λ and 3λ, respectively, corresponding graphs are illustrated.

Here, when a low voltage is supplied to an electrode of the optical modulator, the initial height gap corresponds to the lower position of the structure layer 200 and can be defined as ε_{N/2}=λN/2, which corresponds to the maximum light power with respect to the 0^{th} diffraction order and to the minimum light power with respect to the 1^{st} diffraction order.

Graphs illustrated in FIG. 9 to 12 show a case where a wavelength λ is equal to 532 nm, i.e., a green light beam. In case of a light beam of another wavelength instead of the green light beam, as described above, it is possible to calculate an optimal ridge-hole difference and to apply the optimal ridge-hole difference to design of the optimal optical modulator.

The present invention provides an optical modulator for maximizing the contrast ratio, as described above, by using the relation between the width of the hole and the ridge of the upper mirror, the ridge being measured in parallel with the direction of distribution of diffraction gratings.

When the optical modulator ideally includes a structure layer without bending property, the ridge-hole difference should be a negative number (that is, the width of the hole is larger than that of the ridge) (see FIG. 9) and simply is dependent on the height gap ε. The more the height gap ε increases, the more the ridge-hole difference reduces.

When the optical modulator includes bending property during the manufacturing process, such bending property is characterized as a bending sag and the optimal ridge-hole difference is also affected by the bending sag.

An effect by the height gap is contrary to an effect by the bending sag. While the more the bending sag increases, the more the optimal ridge-hole difference increases (see FIG. 9 to 12), the more the height gap increases, the more the optimal ridge-hole difference decreases.

Here, the height gap corresponds to an initial separation distance between the upper mirror and the lower mirror, and the bending sag corresponds to a degree of tilting of the upper mirror.

While the present invention has been described with reference to exemplary embodiments thereof, it will be understood by those skilled in the art that various changes and modification in forms and details may be made without departing from the spirit and scope of the present invention as defined by the appended claims.

1. A diffraction-type optical modulator comprising:
a board;
a lower mirror formed on the board;
an upper mirror located apart from the lower mirror by a predetermined gap, having a hole, separated into at least two ridges by the hole, and movable up and down; and,
an actuator moving the upper mirror in accordance with a driving signal and changing the separation distance,
whereas a part of incident light beam reflects from the upper mirror, the rest of the incident light beam passes through the hole and reflects from the lower mirror, and then passes through the hole.

2. The diffraction-type optical modulator of claim 1, wherein a width of the ridge and a width of the hole are determined by an initial separation distance between the upper mirror and the lower mirror.

3. The diffraction-type optical modulator of claim 2, wherein the initial separation distance is intended to output a maximum light power at 0^{th} diffraction order when a light beam reflected from the upper mirror and a light beam reflected from the lower mirror overlap with each other.

4. The diffraction-type optical modulator of claim 2, wherein the initial separation distance is intended to output a minimum light power at 1^{st} diffraction order when a light beam reflected from the upper mirror and a light beam reflected from the lower mirror overlap with each other.

5. The diffraction-type optical modulator of claim 2, wherein the more the initial separation distance increases, the more a difference between the width of the ridge and the width of the hole reduces.

6. The diffraction-type optical modulator of claim 2, wherein the width of the hole is larger than the width of the ridge.

7. The diffraction-type optical modulator of claim 1, wherein the width of the ridge and the width of the hole are determined by a tilting of the upper mirror.

8. The diffraction-type optical modulator of claim 7, wherein the more a degree of the tilting increases, the more the difference between the width of the ridge and the width of the hole increases.

9. The diffraction-type optical modulator of claim 1, wherein the width of the ridge and the width of the hole are determined by the initial separation distance between the upper mirror and the lower mirror and by the tilting of the upper mirror.

10. The diffraction-type optical modulator of claim 9, wherein the initial separation distance is intended to output a maximum light power at 0^{th} diffraction order when a light beam reflected from the upper mirror and a light beam reflected from the lower mirror overlap with each other.

11. The diffraction-type optical modulator of claim 9, wherein the initial separation distance is intended to output a minimum light power at 1^{st} diffraction order when a light beam reflected from the upper mirror and a light beam reflected from the lower mirror overlap with each other.

12. The diffraction-type optical modulator of claim 9, wherein the more the initial separation distance increases, the more a difference between the width of the ridge and the width of the hole reduces.

13. The diffraction-type optical modulator of claim 9, wherein the more a degree of the tilting increases, the more the difference between the width of the ridge and the width of the hole increases.

14. A display apparatus comprising a light source, a diffraction-type optical modulator modulating an incident light beam from the light source in accordance with an image signal and outputting the modulated light beam, and a projector projecting the modulated light beam on a predetermined area, the diffraction-type optical modulator comprising:
a board;
a lower mirror formed on the board;
an upper mirror located apart from the lower mirror by a predetermined gap, having a hole, separated into at least two ridges by the hole, and movable up and down; and,
an actuator moving the upper mirror in accordance with a driving signal and changing the separation distance,
whereas a part of incident light beam reflects from the upper mirror, the rest of the incident light beam passes through the hole and reflects from the lower mirror, and then passes through the hole.
